(19) United States
(12) Patent Application Publication
(10) Pub. No.: US 2026/0354367 A1
(43) Pub. Date: Nov. 12, 2026

(54) SIDE-LIGHT MOSQUITO-KILLING LAMP

(71) Applicant: Zhongyuan International E-commerce (Shenzhen) Co., Ltd., Shenzhen (CN)

(72) Inventor: Liyong Wang, Shenzhen (CN)

(21) Appl. No.: 19/221,892

(22) Filed: May 29, 2025

(30) Foreign Application Priority Data
May 8, 2025 (CN) 202520899708.9

(51) Int. Cl. A01M 1/22; A01M 1/08

(52) U.S. Cl. CPC A01M 1/223; A01M 1/08

(57) ABSTRACT

Disclosed is a side-light mosquito-killing lamp, including a housing assembly, an insect-killing assembly, a control circuit board, and a collection box. The housing assembly includes a top cover, a first bracket, a second bracket, and a base. The insect-killing assembly includes a main lamp tube, an electric grid, a protective net, and at least one side lamp tube. The second bracket includes a fixing part and a fixing bracket. The electric grid includes a first fixing ring and a second fixing ring. First conductive columns and second conductive columns are spaced apart from each other in a staggered manner, forming an electrical circuit through contact with any mosquito at any position. The present disclosure facilitates subsequent centralized disposal of killed mosquitoes, ultimately achieves a large illumination range, a large trapping range, an optimal mosquito-killing effect, and convenient mosquito disposal, and enhances environmental adaptability of the mosquito-killing lamp.

### CROSS REFERENCE TO RELATED APPLICATIONS

The present application claims the benefit of Chinese Patent Application No. 2025208997089 filed on May 8, 2025, the contents of which are incorporated herein by reference in their entirety.

### TECHNICAL FIELD

The present disclosure relates to the technical field of mosquito-killing lamps, and in particular to a side-light mosquito-killing lamp.

### BACKGROUND

A mosquito-killing lamp of the prior art is primarily designed based on phototaxis of mosquitoes, which lures mosquitoes through a primary light source (such as an ultraviolet lamp, a LED lamp, or the like), and captures mosquitoes through combination of mosquito-killing devices such as an electric grid, a fan, or adhesives. A light source of the mosquito-killing lamp of the prior art is typically concentrated at a top, middle, or bottom of the lamp, resulting in vertically diffused light coverage. Additionally, due to obstruction of the primary light source by the electric grid and a protective net, it is difficult to effectively cover a lateral area, such that a mosquito easily escapes a trapping range when approaching from the lateral area. Although a streetlight or a desk lamp partially integrating mosquito-killing functions has lighting and mosquito-killing functions, a light source thereof is designed mainly for illumination, without consideration of guiding effect of lateral light sources on mosquito activity paths.

Therefore, in the prior art, absence of lateral auxiliary light sources for the mosquito-killing lamp results in limitations in an illumination range and a trapping range, as well as poor environmental adaptability, particularly significant effect degradation in complex lighting conditions or scenarios of multi-directional mosquito activity. Therefore, there is an urgent need for a mosquito-killing lamp with an integrated side light design, to extend the trapping range through cooperation of multi-directional light sources and enhance mosquito-killing efficiency and scenario adaptability.

### SUMMARY

An objective of the present disclosure is to provide a side-light mosquito-killing lamp, with an aim to overcome defects of mosquito-killing lamps of the prior art including limitations in an illumination range and a lateral trapping range, extend the trapping range through cooperation of multi-directional light sources, and enhance mosquito-killing efficiency and scenario adaptability.

In order to achieve the above objective, the present disclosure provides a side-light mosquito-killing lamp, and the side-light mosquito-killing lamp includes a housing assembly, an insect-killing assembly, a control circuit board, and a collection box;
the housing assembly includes a top cover, a first bracket, a second bracket, and a base that are arranged from top to bottom;
the control circuit board is arranged between the top cover and the first bracket;
the insect-killing assembly includes a main lamp tube arranged between the first bracket and the second bracket, an electric grid spaced around the main lamp tube, a protective net spaced around the electric grid, and at least one side lamp tube located outside the protective net;
the collection box is surroundingly provided with a collection chamber below the electric grid;
the base is annular and forms a mounting cavity in a surrounded manner, and the collection box is detachably mounted on an inner wall of the mounting cavity;
the second bracket includes a fixing part located below the electric grid and a fixing bracket surrounding the fixing part; the fixing part includes a mounting groove formed at a center thereof and a plurality of first through holes spaced around the mounting groove; a bottom of the main lamp tube abuts against a bottom of the mounting groove, and the first through holes are configured for the mosquitoes killed by the electric grid to fall into the collection chamber; and
the electric grid includes a first fixing ring connected to the first bracket, and a second fixing ring connected to the second bracket; the first fixing ring is electrically connected to a positive terminal of the control circuit board, and the second fixing ring is electrically connected to a negative terminal of the control circuit board; the first fixing ring is provided with a plurality of first conductive columns spaced apart from each other in a parallel and vertical manner, and the second fixing ring is provided with a plurality of second conductive columns spaced apart from each other in a parallel and vertical manner; and the first conductive columns and the second conductive columns are spaced apart from each other in a staggered manner, forming an electrical circuit through contact with any mosquito at any position.

In a preferred embodiment, the side lamp tube includes a lamp housing and a light strip arranged inside the lamp housing, and the light strip is electrically connected to the control circuit board; the first bracket extends outward at a predetermined position to form a first fixing block provided with a first fixing groove, the second bracket extends outward at a predetermined position to form a second fixing block with a second fixing groove, the top cover is provided with a first avoidance groove for accommodating the first fixing block, and the base is provided with a second avoidance groove for accommodating the second fixing block; and one end of the lamp housing is snap-fitted into the first fixing groove, and the other end thereof is snap-fitted into the second fixing groove.

In a preferred embodiment, each side lamp tube further includes a transparent protective cover, and the lamp housing is spaced inside the protective cover; and one end of the protective cover is snap-fitted between an outer side of the first fixing block and an inner wall of the first avoidance groove, and the other end thereof is snap-fitted between an outer side of the second fixing block and an inner wall of the second avoidance groove.

In a preferred embodiment, a cross-section of the lamp housing is semi-circular, and the light strip is adhesively fixed to an inner plane of the lamp housing in a length direction.

In a preferred embodiment, the number of the side lamp tubes is two, and the two are symmetrically arranged on both sides of the housing assembly.

In a preferred embodiment, a side of the first bracket close to the second bracket is provided with a circular limiting ring, and a snap-fit groove is formed on an inner side of the limiting ring; and one end of the main lamp tube is snap-fitted inside the snap-fit groove, and the first fixing ring is sleeved over an outer side of the limiting ring.

In a preferred embodiment, a center of the fixing bracket is provided with a central through hole, and an edge of the fixing part is fixed to an inner wall of the central through hole; the fixing bracket is provided with a plurality of second through holes spaced around the central through hole; the second bracket further includes a hollow cover located above the central through hole, and the hollow cover includes an avoidance hole formed at a center thereof and a plurality of third through holes spaced around the avoidance hole; the avoidance hole is configured for the main lamp tube to pass through; and a plurality of supporting plates spaced from each other are arranged along an edge of the hollow cover, a supporting groove is formed above each of the supporting plates, and the second fixing ring is simultaneously arranged in a plurality of the supporting grooves.

In a preferred embodiment, a first penetrating hole is formed when a side of the first conductive column close to the first fixing ring is recessed outward at a predetermined position, and a second penetrating hole is formed when a side thereof away from the first fixing ring is recessed outward at a predetermined position; a third penetrating hole is formed when a side of the second conductive column close to the second fixing ring is recessed outward at a predetermined position, and a fourth penetrating hole is formed when a side thereof away from the second fixing ring is recessed outward at a predetermined position; all the first penetrating holes and all the fourth penetrating holes are formed in a staggered manner and snap-fitted through a first insulating ring in a penetrated manner; and all the second penetrating holes and all the third penetrating holes are formed in a staggered manner and snap-fitted through a second insulating ring in a penetrated manner.

In a preferred embodiment, the inner wall of the mounting cavity is circumferentially provided with a circular limiting flange, and the limiting flange is provided with a plurality of notches and limiting blocks; an outer surface of the collection box is provided with mounting blocks fitted with the notches; each of the mounting blocks rotates circumferentially after penetrating through one corresponding notch to abut against an upper side of the limiting flange, such that the collection box is mounted on the inner wall of the mounting cavity; and the limiting blocks are configured to limit rotation of the mounting blocks.

In a preferred embodiment, the protective net includes a plurality of connecting rods and a plurality of protective rings spaced apart from each other in a parallel and vertical manner; each of the connecting rods is fixedly connected to all the protective rings; the first bracket is provided with first insertion holes fitted with the connecting rods, and the second bracket is provided with second insertion holes fitted with the connecting rods; and one end of the connecting rod is inserted into one corresponding first insertion hole, and the other end thereof is inserted into one corresponding second insertion hole.

The side-light mosquito-killing lamp provided by the present disclosure, through the electric grid spaced around the main lamp tube and at least one side lamp tube located outside the protective net, enhances the illumination range and brightness as well as the trapping range of a lateral area, such that a mosquito is easily killed by the electric grid when approaching the side lamp tube, and the mosquito killed falls into the collection chamber through the first through hole of the second bracket, which facilitates subsequent removal of the collection box for centralized disposal of killed mosquitoes, ultimately achieves a large trapping range, an optimal mosquito-killing effect, and convenient mosquito disposal, and enhances environmental adaptability of the mosquito-killing lamp.

### BRIEF DESCRIPTION OF THE DRAWINGS

To describe the technical solution in the examples of the present disclosure more clearly, the accompanying drawings required for describing the examples are briefly described below. It should be understood that the following accompanying drawings show merely some examples of the present disclosure, and therefore it should not be construed as a limitation to the scope. Those of ordinary skill in the art can also derive other accompanying drawings from these accompanying drawings without making inventive efforts.

FIG. 1 is a space diagram of a side-light mosquito-killing lamp provided by the present disclosure.

FIG. 2 is a front view of the side-light mosquito-killing lamp shown in FIG. 1.

FIG. 3 is a semi-sectional view of an XZ plane of the side-light mosquito-killing lamp shown in FIG. 1.

FIG. 4 is a semi-sectional view of a YZ plane of the side-light mosquito-killing lamp shown in FIG. 1.

FIG. 5 is a space diagram of another view of the side-light mosquito-killing lamp shown in FIG. 1.

FIG. 6 is a three-dimensional exploded view of the side-light mosquito-killing lamp shown in FIG. 1.

FIG. 7 is a three-dimensional exploded view of a partial structure of the side-light mosquito-killing lamp shown in FIG. 6.

FIG. 8 is a space diagram of an electric grid of the side-light mosquito-killing lamp shown in FIG. 1.

FIG. 9 is a schematic diagram of a partially enlarged structure of the electric grid shown in FIG. 8 in a circle A.

FIG. 10 is a three-dimensional exploded view of a collection box and a base in the side-light mosquito-killing lamp shown in FIG. 1.

Reference numerals in the figures: 100–side-light mosquito-killing lamp; 10–housing assembly; 11–first bracket; 101–first fixing groove; 111–first fixing block; 112–first insertion hole; 113–limiting ring; 1131–snap-fit groove; 12–second bracket; 102–second fixing groove; 121–second fixing block; 122–second insertion hole; 123–fixing part; 1231–mounting groove; 1232–first through hole; 124–fixing bracket; 1241–central through hole; 1242–second through hole; 125–hollow cover; 1251–avoidance hole; 1252–third through hole; 126–supporting plate; 1261–supporting groove; 13–top cover; 131–hook; 132–first avoidance groove; 14–base; 104–mounting cavity; 141–second avoidance groove; 142–limiting flange; 1421–notch; 143–limiting block; 20–insect-killing assembly; 21–main lamp tube; 22–electric grid; 221–first fixing ring; 2211–first conductive column; 2212–first penetrating hole; 2213–second penetrating hole; 222–second fixing ring; 2221–second conductive column; 2222–third penetrating hole; 2223–fourth penetrating hole; 23–protective net; 231–connecting rod; 232–protective ring; 24–side lamp tube; 241–lamp housing; 2411–recess; 242–light strip; 243–protective cover; 25–first insulating ring; 26–second insulating ring; 30–control circuit board; 40–collection box; 401–collection chamber; and 41–mounting block.

### DETAILED DESCRIPTIONS OF THE EMBODIMENTS

To make objectives, technical solutions and beneficial technical effects of the present disclosure clearer, the present disclosure will be further described in detail with reference to accompanying drawings and specific embodiments. It should be understood that the specific embodiments described in the present specification are merely illustrative of the present disclosure and are not intended to limit the present disclosure.

It should also be understood that the terms used in the present specification are merely for the purpose of describing specific examples and are not intended to limit the present disclosure. As used in the present specification and the appended claims, the singular terms "a", "an" and "the" are intended to include the plural forms unless clearly indicated otherwise in the context.

It should be further understood that the term “and/or” as used in the present specification and the appended claims refers to and includes any or all possible combinations of one or more of the associated listed items.

In an example of the present disclosure, a side-light mosquito-killing lamp 100 is provided for luring and killing mosquitoes, moths, and the like in a nighttime environment, and a lateral auxiliary light source is further arranged outside a primary light source to enhance an illumination intensity and a trapping range of a lateral area.

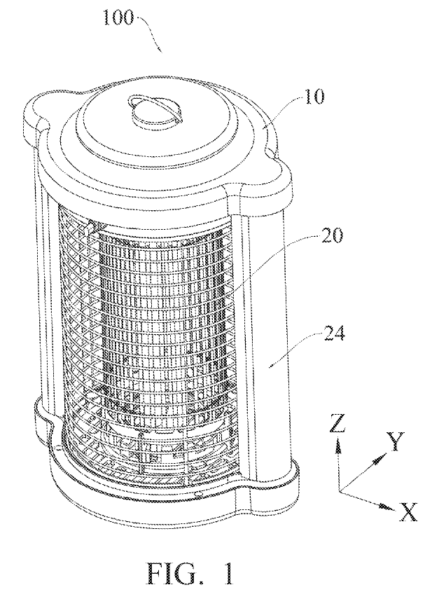

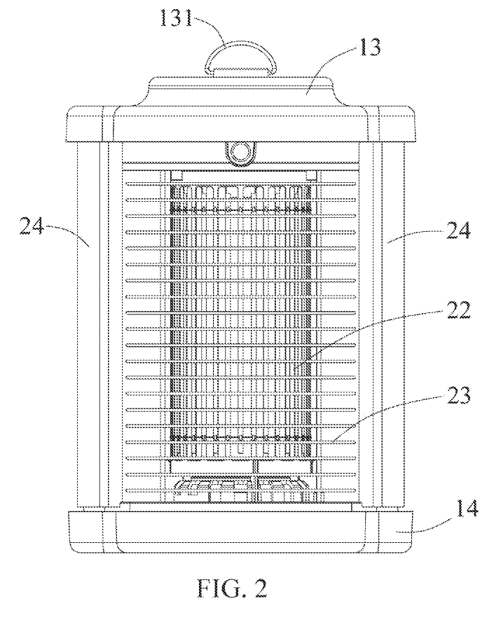

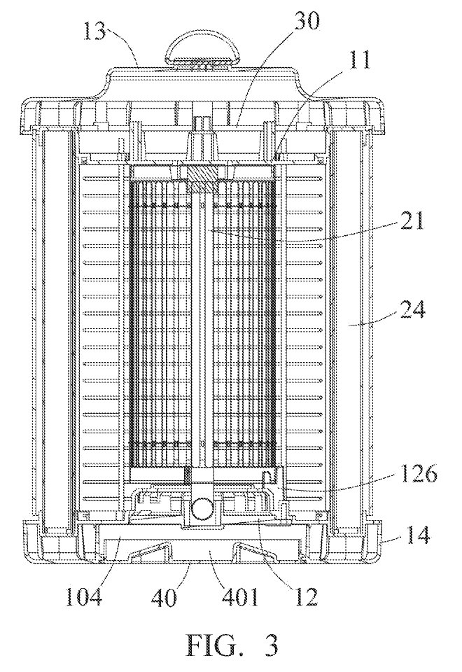

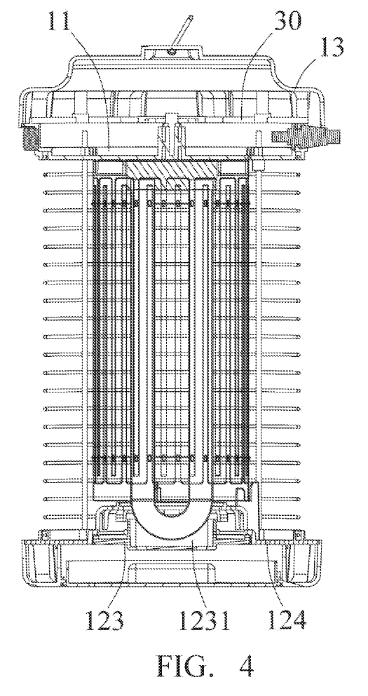

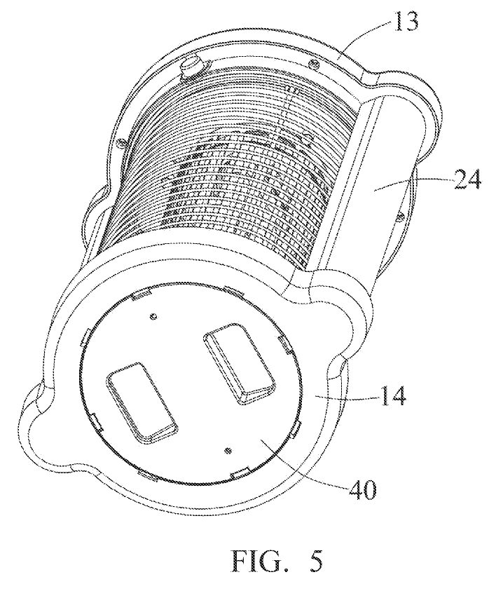

As shown in FIGS. 1-7, the side-light mosquito-killing lamp 100 includes a housing assembly 10, an insect-killing assembly 20, a control circuit board 30, and a collection box 40.

Specifically, the housing assembly 10 includes a top cover 13, a first bracket 11, a second bracket 12, and a base 14 that are arranged from top to bottom. The control circuit board 30 is arranged between the top cover 13 and the first bracket 11. The top cover 13 is provided with a hook 131 for hanging the lamp at a predetermined position, and fully encloses the first bracket 11 below to prevent rainwater or debris from damaging the control circuit board 30. The base 14 is enclosed below the second bracket 12.

The control circuit board 30 includes a battery and a processor, where the processor controls whether the battery outputs current. It is to be noted that for a structure and implementation principle of the control circuit board 30, reference to the prior art can be made, which will not be described in detail herein.

The insect-killing assembly 20 includes a main lamp tube 21 arranged between the first bracket 11 and the second bracket 12, an electric grid 22 spaced around the main lamp tube 21, a protective net 23 spaced around the electric grid 22, and at least one side lamp tube 24 located outside the protective net 23. That is, the main lamp tube 21, the electric grid 22, the protective net 23, and the side lamp tube 24 are arranged from inside to outside. The main lamp tube 21 is configured to provide the primary light source and lure mosquitoes with phototaxis to approach the electric grid 22. The electric grid 22 is configured to kill mosquitoes through high-voltage discharge, and also provides certain physical protection for the main lamp tube 21. The protective net 23 prevents any user or larger animal from accidental contact with the electric grid 22 so as to avoid electric shock and provide protection. A relatively large mesh size of the protective net 23 may be arranged, such that mosquitoes pass through smoothly. The side lamp tube 24 is arranged to be outermost with minimal obstruction, and configured to provide an auxiliary light source and increase an illumination range and brightness so as to extend the trapping range.

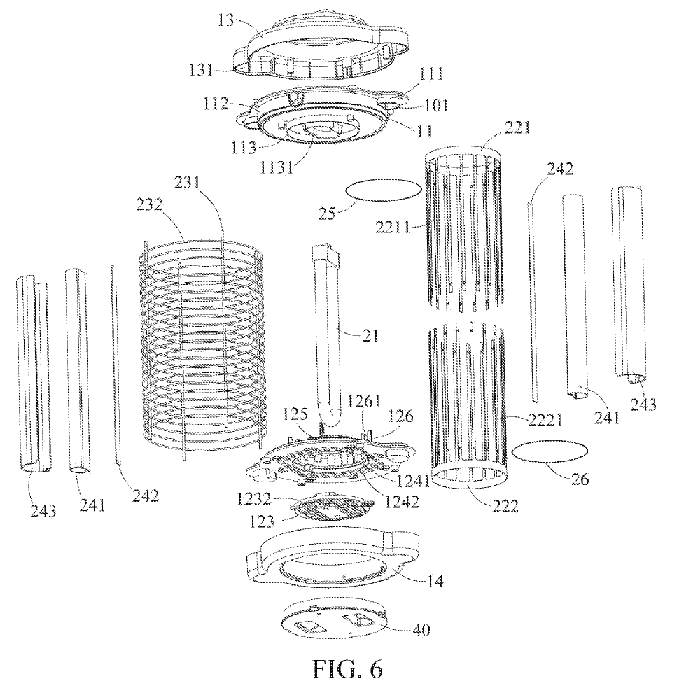

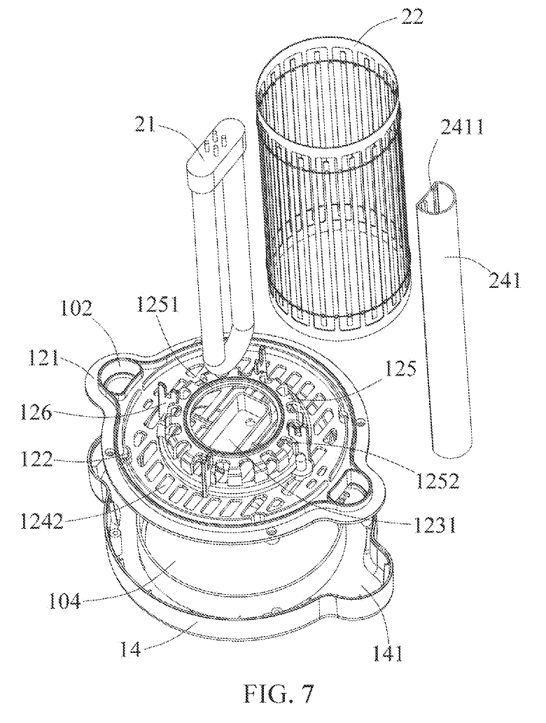

As shown in FIGS. 6 and 7, the side lamp tube 24 includes a lamp housing 241 and a light strip 242 arranged inside the lamp housing 241. The light strip 242 is electrically connected to the control circuit board 30, such that the control circuit board 30 supplies power to the light strip 242 and controls an on/off state thereof.

The first bracket 11 extends outward at a predetermined position to form a first fixing block 111 provided with a first fixing groove 101, and the second bracket 12 extends outward at a predetermined position to form a second fixing block 121 with a second fixing groove 102. The first fixing block 111 and the second fixing block 121 respectively form a lug structure that protrudes outward relative to the first bracket 11 or the second bracket 12. The top cover 13 is provided with a first avoidance groove 132 for accommodating the first fixing block 111, and the base 14 is provided with a second avoidance groove 141 for accommodating the second fixing block 121. One end of the lamp housing 241 is snap-fitted into the first fixing groove 101, and the other end thereof is snap-fitted into the second fixing groove 102, thereby achieving fixation of the lamp housing 241.

Further, each side lamp tube 24 further includes a transparent protective cover 243, and the lamp housing 241 is spaced inside the protective cover 243. A cross-sectional shape of the protective cover 243 may be consistent with a cross-sectional shape of the lamp housing 241, and the protective cover 243 is larger in size. One end of the protective cover 243 is snap-fitted between an outer side of the first fixing block 111 and an inner wall of the first avoidance groove 132, and the other end thereof is snap-fitted between an outer side of the second fixing block 121 and an inner wall of the second avoidance groove 141. Therefore, the protective cover 243 is configured to enhance physical protection of the lamp housing 241, so as to prevent damage to the lamp housing 241 from an external impact.

Further, a cross-section of the lamp housing 241 is semi-circular, and the light strip 242 is adhesively fixed to an inner plane of the lamp housing 241 in a length direction. The inner plane of the lamp housing 241 is provided with a flat recess 2411 in the length direction, and the light strip 242 may be alternatively snap-fitted into the recess 2411 for detachable fixing.

As illustrated in an example, the number of the side lamp tubes 24 is two, and the two are symmetrically arranged on both sides of the housing assembly 10, thereby increasing an illumination range on both sides. Alternatively, Of course, a plurality of the side lamp tubes 24 may be arranged uniformly around the protective net 23.

As shown in FIGS. 6 and 7, the protective net 23 includes a plurality of connecting rods 231 and a plurality of protective rings 232 spaced apart from each other in a parallel and vertical manner. The protective rings 232 are circular. Each of the connecting rods 231 is fixedly connected to all the protective rings 232, such that the protective net 23 has a cylindrical mesh structure. The first bracket 11 is provided with first insertion holes 112 fitted with the connecting rods 231, and the second bracket 12 is provided with second insertion holes 122 fitted with the connecting rods 231. One end of the connecting rod 231 is inserted into one corresponding first insertion hole 112, and the other end thereof is inserted into one corresponding second insertion hole 122.

In an example of the present disclosure, the collection box 40 is surroundingly provided with a collection chamber 401 below the electric grid 22. The collection chamber 401 is configured to collect mosquitoes killed by the electric grid 22, so as to facilitate subsequent centralized disposal of killed mosquitoes.

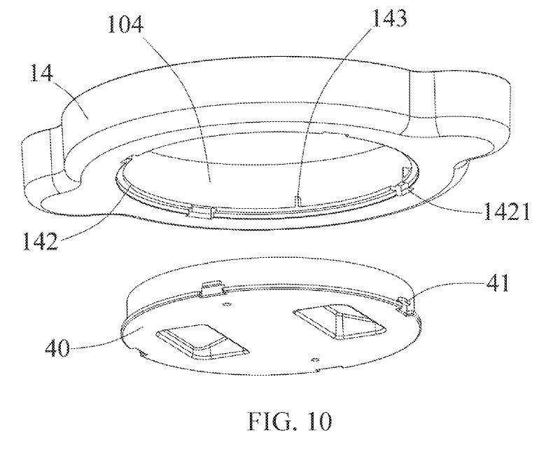

As shown in FIG. 10, the base 14 is annular and forms a cylindrical or prismatic mounting cavity 104 in a surrounded manner, and the collection box 40 is detachably mounted on an inner wall of the mounting cavity 104.

Specifically, the inner wall of the mounting cavity 104 is circumferentially provided with a circular limiting flange 142. The limiting flange 142 is provided with a plurality of notches 1421 and limiting blocks 143. An outer surface of the collection box 40 is provided with mounting blocks 41 fitted with the notches 1421. Each of the mounting blocks 41 rotates circumferentially after penetrating through one corresponding notch 1421 to abut against an upper side of the limiting flange 142, such that the collection box 40 is mounted on the inner wall of the mounting cavity 104, and in this case, the mounting blocks 41 and the notches 1421 are arranged in a staggered manner. The limiting blocks 143 are configured to limit rotation of the mounting blocks 41. To remove the collection box 40, the collection box 40 rotates reversely, such that the mounting blocks 41 are aligned with the corresponding notches 1421, and then the collection box 40 is removed downward.

In this example, the second bracket 12 includes a fixing part 123 located below the electric grid 22 and a fixing bracket 124 surrounding the fixing part 123. A center of the fixing bracket 124 is provided with a central through hole 1241, and the fixing part 123 is mounted at the central through hole 1241. The fixing part 123 includes a mounting groove 1231 formed at a center thereof and a plurality of first through holes 1232 spaced around the mounting groove 1231. A bottom of the main lamp tube 21 abuts against a bottom of the mounting groove 1231, and the first through holes 1232 are configured for the mosquitoes killed by the electric grid 22 to fall into the collection chamber 401.

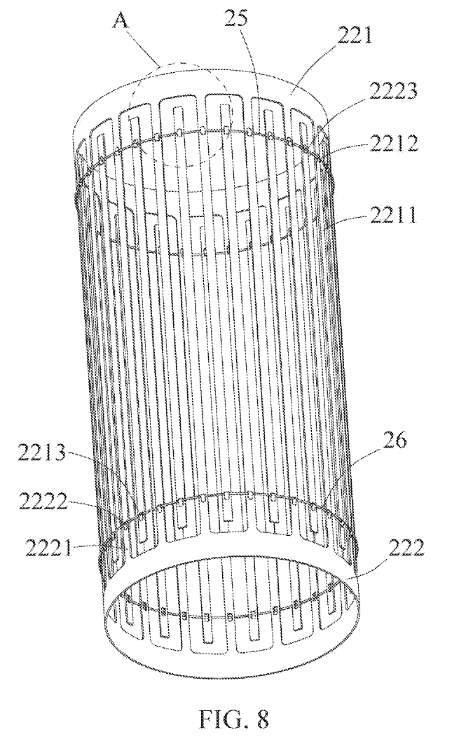

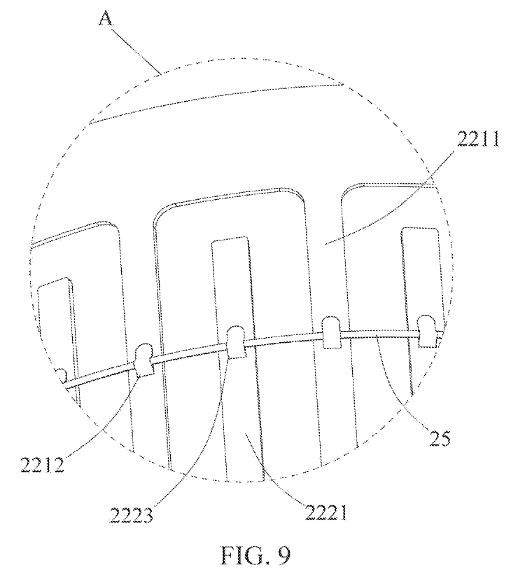

As shown in FIGS. 6-9, the electric grid 22 includes a first fixing ring 221 connected to the first bracket 11, and a second fixing ring 222 connected to the second bracket 12. The first fixing ring 221 is electrically connected to a positive terminal of the control circuit board 30, and the second fixing ring 222 is electrically connected to a negative terminal of the control circuit board 30. The first fixing ring 221 is provided with a plurality of first conductive columns 2211 spaced apart from each other in a parallel and vertical manner, and the second fixing ring 222 is provided with a plurality of second conductive columns 2221 spaced apart from each other in a parallel and vertical manner. The first conductive columns 2211 and the second conductive columns 2221 are spaced apart from each other in a staggered manner and do not come into contact with each other. When a mosquito comes into contact with the electric grid 22 at any position, an electrical circuit is formed between a positive electrode of the battery, the first fixing ring 221, the first conductive columns 2211, the mosquito, the second conductive columns 2221, the second fixing ring 222, and a negative electrode of the battery; and current flows through the mosquito to deliver an electric shock, thereby achieving an effect of killing the mosquito.

A first penetrating hole 2212 is formed when a side of the first conductive column 2211 close to the first fixing ring 221 is recessed outward at a predetermined position, and a second penetrating hole 2213 is formed when a side thereof away from the first fixing ring 221 is recessed outward at a predetermined position. Openings of the first penetrating hole 2212 and the second penetrating hole 2213 formed on both sides thereof are circumferentially arranged on a cylindrical face where the first conductive columns 2211 are located. A third penetrating hole 2222 is formed when a side of the second conductive column 2221 close to the second fixing ring 222 is recessed outward at a predetermined position, and a fourth penetrating hole 2223 is formed when a side thereof away from the second fixing ring 222 is recessed outward at a predetermined position. Openings of the third penetrating hole 2222 and the fourth penetrating hole 2223 formed on both sides thereof are circumferentially arranged on a cylindrical face where the second conductive columns 2221 are located. All the first penetrating holes 2212 and all the fourth penetrating holes 2223 are formed in a staggered manner and snap-fitted through a first insulating ring 25 in a penetrated manner, such that a side of each of the first conductive columns 2211 close to the first fixing ring 221 is fixedly connected to a side of each of the second conductive columns 2221 away from the second fixing ring 222; and all the second penetrating holes 2213 and all the third penetrating holes 2222 are formed in a staggered manner and snap-fitted through a second insulating ring 26 in a penetrated manner, such that a side of each of the first conductive columns 2211 away from the first fixing ring 221 is fixedly connected to a side of each of the second conductive columns 2221 close to the second fixing ring 222, and finally all the first conductive columns 2211 and all the second conductive columns 2221 jointly form a cylindrical mesh structure with uniform gaps therebetween, thereby preventing short circuits.

In this example, a side of the first bracket 11 close to the second bracket 12 is provided with a circular limiting ring 113. A snap-fit groove 1131 is formed on an inner side of the limiting ring 113, and a circuit interface electrically connected to the control circuit board 30 is arranged at a bottom of the snap-fit groove 1131. One end of the main lamp tube 21 is snap-fitted inside the snap-fit groove 1131 and is electrically connected to the control circuit board 30 through the circuit interface.

Further, the first fixing ring 221 is sleeved over an outer side of the limiting ring 113, to snap-fit and limit an upper end of the electric grid 22. The fixing bracket 124 is provided with a plurality of second through holes 1242 spaced around the central through hole 1241, and the second through holes 1242 are also configured for the mosquitoes killed by the electric grid 22 and slightly farther away from the electric grid 22 to fall into the collection chamber 401.

The second bracket 12 further includes a hollow cover 125 located above the central through hole 1241. The hollow cover 125 includes an avoidance hole 1251 formed at a center thereof and a plurality of third through holes 1252 spaced around the avoidance hole 1251. The avoidance hole 1251 is configured for the main lamp tube 21 to pass through. A plurality of supporting plates 126 spaced from each other are arranged along an edge of the hollow cover 125, and for example, all the supporting plates 126 may be located on a same circle. A supporting groove 1261 is formed above each of the supporting plates 126, and the second fixing ring 222 is simultaneously arranged in the plurality of supporting grooves 1261, thereby fixing a bottom of the electric grid 22.

To sum up, the side-light mosquito-killing lamp 100 provided by the present disclosure, through the electric grid 22 spaced around the main lamp tube 21 and at least one side lamp tube 24 located outside the protective net 23, enhances the illumination range and brightness as well as the trapping range of a lateral area, such that a mosquito is easily killed by the electric grid 22 when approaching the side lamp tube 24, and the mosquito killed falls into the collection chamber 401 through the first through hole 1232 of the second bracket 12, which facilitates subsequent removal of the collection box 40 for centralized disposal of killed mosquitoes, ultimately achieves a large trapping range, an optimal mosquito-killing effect, and convenient mosquito disposal, and enhances environmental adaptability of the mosquito-killing lamp.

The present disclosure is not limited merely to what is described in the specification and the embodiments, such that additional advantages and modifications can be readily achieved by those skilled in the art. Without departing from the spirit and scope of the general concept as defined by the claims and the equivalents, the present disclosure is not limited to the specific details, representative apparatus, and illustrative examples as shown and described herein.

What is claimed is:

1. A side-light mosquito-killing lamp, comprising a housing assembly, an insect-killing assembly, a control circuit board, and a collection box;
the housing assembly comprises a top cover, a first bracket, a second bracket, and a base that are arranged from top to bottom;
the control circuit board is arranged between the top cover and the first bracket;
the insect-killing assembly comprises a main lamp tube arranged between the first bracket and the second bracket, an electric grid spaced around the main lamp tube, a protective net spaced around the electric grid, and at least one side lamp tube located outside the protective net;
the collection box is surroundingly provided with a collection chamber below the electric grid;
the base is annular and forms a mounting cavity in a surrounded manner, and the collection box is detachably mounted on an inner wall of the mounting cavity;
the second bracket comprises a fixing part located below the electric grid and a fixing bracket surrounding the fixing part; the fixing part comprises a mounting groove formed at a center thereof and a plurality of first through holes spaced around the mounting groove; a bottom of the main lamp tube abuts against a bottom of the mounting groove, and the first through holes are configured for the mosquitoes killed by the electric grid to fall into the collection chamber; and
the electric grid comprises a first fixing ring connected to the first bracket, and a second fixing ring connected to the second bracket; the first fixing ring is electrically connected to a positive terminal of the control circuit board, and the second fixing ring is electrically connected to a negative terminal of the control circuit board; the first fixing ring is provided with a plurality of first conductive columns spaced apart from each other in a parallel and vertical manner, and the second fixing ring is provided with a plurality of second conductive columns spaced apart from each other in a parallel and vertical manner; and the first conductive columns and the second conductive columns are spaced apart from each other in a staggered manner, forming an electrical circuit through contact with any mosquito at any position.

2. The side-light mosquito-killing lamp according to claim 1, wherein the side lamp tube comprises a lamp housing and a light strip arranged inside the lamp housing, and the light strip is electrically connected to the control circuit board; the first bracket extends outward at a predetermined position to form a first fixing block provided with a first fixing groove, the second bracket extends outward at a predetermined position to form a second fixing block with a second fixing groove, the top cover is provided with a first avoidance groove for accommodating the first fixing block, and the base is provided with a second avoidance groove for accommodating the second fixing block; and one end of the lamp housing is snap-fitted into the first fixing groove, and the other end thereof is snap-fitted into the second fixing groove.

3. The side-light mosquito-killing lamp according to claim 2, wherein each side lamp tube further comprises a transparent protective cover, and the lamp housing is spaced inside the protective cover; and one end of the protective cover is snap-fitted between an outer side of the first fixing block and an inner wall of the first avoidance groove, and the other end thereof is snap-fitted between an outer side of the second fixing block and an inner wall of the second avoidance groove.

4. The side-light mosquito-killing lamp according to claim 2, wherein a cross-section of the lamp housing is semi-circular, and the light strip is adhesively fixed to an inner plane of the lamp housing in a length direction.

5. The side-light mosquito-killing lamp according to claim 2, wherein the number of the side lamp tubes is two, and the two are symmetrically arranged on both sides of the housing assembly.

6. The side-light mosquito-killing lamp according to claim 1, wherein a side of the first bracket close to the second bracket is provided with a circular limiting ring, and a snap-fit groove is formed on an inner side of the limiting ring; and one end of the main lamp tube is snap-fitted inside the snap-fit groove, and the first fixing ring is sleeved over an outer side of the limiting ring.

7. The side-light mosquito-killing lamp according to claim 6, wherein a center of the fixing bracket is provided with a central through hole, and an edge of the fixing part is fixed to an inner wall of the central through hole; the fixing bracket is provided with a plurality of second through holes spaced around the central through hole; the second bracket further comprises a hollow cover located above the central through hole, and the hollow cover comprises an avoidance hole formed at a center thereof and a plurality of third through holes spaced around the avoidance hole; the avoidance hole is configured for the main lamp tube to pass through; and a plurality of supporting plates spaced from each other are arranged along an edge of the hollow cover, a supporting groove is formed above each of the supporting plates, and the second fixing ring is simultaneously arranged in a plurality of the supporting grooves.

8. The side-light mosquito-killing lamp according to claim 1, wherein a first penetrating hole is formed when a side of the first conductive column close to the first fixing ring is recessed outward at a predetermined position, and a second penetrating hole is formed when a side thereof away from the first fixing ring is recessed outward at a predetermined position; a third penetrating hole is formed when a side of the second conductive column close to the second fixing ring is recessed outward at a predetermined position, and a fourth penetrating hole is formed when a side thereof away from the second fixing ring is recessed outward at a predetermined position; all the first penetrating holes and all the fourth penetrating holes are formed in a staggered manner and snap-fitted through a first insulating ring in a penetrated manner; and all the second penetrating holes and all the third penetrating holes are formed in a staggered manner and snap-fitted through a second insulating ring in a penetrated manner.

9. The side-light mosquito-killing lamp according to claim 1, wherein the inner wall of the mounting cavity is circumferentially provided with a circular limiting flange, and the limiting flange is provided with a plurality of notches and limiting blocks; an outer surface of the collection box is provided with mounting blocks fitted with the notches; each of the mounting blocks rotates circumferentially after penetrating through one corresponding notch to abut against an upper side of the limiting flange, such that the collection box is mounted on the inner wall of the mounting cavity; and the limiting blocks are configured to limit rotation of the mounting blocks.

10. The side-light mosquito-killing lamp according to claim 1, wherein the protective net comprises a plurality of connecting rods and a plurality of protective rings spaced apart from each other in a parallel and vertical manner; each of the connecting rods is fixedly connected to all the protective rings; the first bracket is provided with first insertion holes fitted with the connecting rods, and the second bracket is provided with second insertion holes fitted with the connecting rods; and one end of the connecting rod is inserted into one corresponding first insertion hole, and the other end thereof is inserted into one corresponding second insertion hole.
